(19) United States
(12) Patent Application Publication
(10) Pub. No.: US 2009/0068511 A1
(43) Pub. Date: Mar. 12, 2009

(54) CATALYST FOR REFORMER OF FUEL CELL, PREPARING METHOD THEREOF, AND REFORMER FOR FUEL CELL AND FUEL CELL SYSTEM INCLUDING SAME

(76) Inventors: Yong-Kul Lee, Yongin-si (KR); Ju-Yong Kim, Yongin-si (KR); Man-Seok Han, Yongin-si (KR); Jun-Sik Kim, Yongin-si (KR); Sung-Chul Lee, Yongin-si (KR); Jin-Goo Ahn, Yongin-si (KR)

Correspondence Address: CHRISTIE, PARKER & HALE, LLP, PO BOX 7068, PASADENA, CA, 91109-7068, US

(21) Appl. No.: 11/869,603

(22) Filed: Oct. 9, 2007

(30) Foreign Application Priority Data
Sep. 6, 2007 (KR) 10-2007-0090648

(51) Int. Cl. H01M 8/18; B01J 23/60

(52) U.S. Cl. 429/20; 502/326; 502/329

(57) ABSTRACT

A catalyst for a reformer of a fuel cell including an active component and a carrier supporting the active component and including zinc oxide. The active component includes a transition metal and a platinum-group metal. Here, the catalyst has a relatively high reforming efficiency with a relatively low amount of platinum-group metal and a reaction temperature that is less than 500° C. to ensure reactor durability.

### CROSS-REFERENCE TO RELATED APPLICATION

This application claims priority to and the benefit of Korean Patent Application No. 10-2007-0090648 filed in the Korean Intellectual Property Office on Sep. 6, 2007, the entire content of which is incorporated herein by reference.

### BACKGROUND OF THE INVENTION

1. Field of the Invention

The present invention relates to a catalyst for a reformer of a fuel cell, a method of preparing the same, a reformer for a fuel cell, and a fuel cell system including the same.

2. Description of the Related Art

A fuel cell is a power generation system for producing electrical energy through an electrochemical redox reaction of an oxidant and a hydrocarbon-based material such as methanol, ethanol, or natural gas.

A fuel cell includes a stack composed of unit cells to produce various ranges of power output.

Representative exemplary fuel cells include a polymer electrolyte membrane fuel cell (PEMFC) and a direct oxidation fuel cell (DOFC). The direct oxidation fuel cell includes a direct methanol fuel cell that uses methanol as a fuel.

The polymer electrolyte fuel cell has relatively high energy density and high power output, but needs a fuel reforming processor for reforming methane, methanol, natural gas, or the like in order to produce a hydrogen-rich gas as the fuel gas.

By contrast, a direct oxidation fuel cell has a lower energy density than that of the polymer electrolyte fuel cell, but it does not need a fuel reforming processor and can operate at room temperature due to its relatively low operation temperature.

In a fuel cell, the stack that generates electricity includes unit cells that are stacked in multiple layers, and each of the unit cells is composed of a membrane-electrode assembly (MEA) and one or more separators (also referred to as bipolar plates). The membrane-electrode assembly is composed of an anode (also referred to as a “fuel electrode” or an “oxidation electrode”), a cathode (also referred to as an “air electrode” or a “reduction electrode”), and a polymer electrolyte membrane between the anode and the cathode.

A fuel is supplied to the anode and adsorbed on catalyst of the anode, and the fuel is oxidized to produce protons and electrons. The electrons are transferred into the cathode via an external circuit, and the protons are transferred to the cathode through the polymer electrolyte membrane. In addition, an oxidant is supplied to the cathode, and the oxidant, protons, and electrons are reacted on catalyst of the cathode to produce heat along with water.

### SUMMARY OF THE INVENTION

An aspect of an embodiment of the present invention is directed toward a catalyst for a reformer of a fuel cell that has a relatively high reforming efficiency with a relatively low amount of platinum-group metal and a reaction temperature that is less than 500° C. to ensure reactor durability.

Another aspect of an embodiment of the present invention is directed toward a method of preparing the catalyst.

Yet another aspect of an embodiment of the present invention is directed toward a fuel cell system that includes the catalyst.

According to an embodiment of the present invention, a catalyst for a reformer of a fuel cell is provided. The catalyst includes an active component having a transition metal and a platinum-group metal, and a carrier supporting the active component and including zinc oxide.

The transition metal may include a metal selected from the group consisting of Co, Cu, Ni, Fe, and combinations thereof.

The transition metal may be in an amount ranging from about 5 to about 20 wt % based on a total weight of the catalyst.

The platinum-group metal may include a metal selected from the group consisting of ruthenium, platinum, rhodium, palladium, iridium, and combinations thereof.

The platinum-group metal may be in an amount ranging from about 0.1 to about 5 wt % based on a total weight of the catalyst.

The active component may include the transition metal and platinum-group metal in a mole ratio ranging from about 33:1 to about 145:1.

The catalyst may further include a co-catalyst selected from the group consisting of an alkali metal, an alkaline-earth metal, and combinations thereof.

The co-catalyst may be in an amount ranging from about 0.05 to about 0.5 moles based on 1 mole of the transition element.

The catalyst is a reforming catalyst for an alcohol fuel.

According to another embodiment of the present invention, a method of preparing a catalyst for a reformer of a fuel cell is provided. The method includes preparing a catalyst precursor solution that includes a platinum-group metal-containing compound, a transition metal-containing compound, and a Zn-containing compound; subjecting the catalyst precursor solution to co-precipitation and aging to obtain a solution; filtering the solution to obtain a filtrate; and drying the filtrate to obtain a resultant and firing the resultant to obtain the catalyst.

The catalyst precursor solution may include a transition metal and a platinum-group metal in a mole ratio ranging from about 33:1 to about 145:1.

The catalyst precursor solution may further include a co-catalyst-containing compound including a metal selected from the group consisting of an alkali metal, an alkaline-earth metal, and combinations thereof.

The co-catalyst may be in an amount ranging from about 0.05 to about 0.5 moles based on 1 mole of the transition metal in the catalyst precursor solution.

The co-precipitation is performed at a temperature ranging from about 30 to about 90° C.

The aging is performed for a time period ranging from about 6 to about 48 hours.

According to another embodiment, a reformer for a fuel cell including a reforming catalyst is provided. The forming catalyst includes an active component having a transition metal and a platinum-group metal, and a carrier supporting the active component and including zinc oxide.

The reformer may include at least two reactors for containing the reforming catalyst, each of the reactors including a flow channel.

The reformer may further include a thermal energy generating element for generating thermal energy through a catalytic oxidization reaction of fuel and an oxidant, and a hydrogen gas generating element for containing the reforming catalyst and for generating hydrogen-rich gas by being supplied with a fuel separately from the thermal energy generating element and adsorbing thermal energy from the thermal energy generating element.

The reformer may further include a first reactor for generating thermal energy through a catalytic oxidation reaction of a fuel and an oxidant, a second reactor for vaporizing mixed fuel with the thermal energy, and a third reactor for generating hydrogen-rich gas from the vaporized mixed fuel with the reforming catalyst. The first to third reactors are stacked adjacent to one another to form an integrated structure.

The fuel may be an alcohol such as ethanol.

According to another embodiment of the present invention, a fuel cell system including a catalyst is provided. The fuel cell system includes a stack for generating electrical energy through an electrochemical reaction of hydrogen and an oxidant, a reformer for generating hydrogen-rich gas from the fuel and supplying the hydrogen-rich gas to the stack, a fuel supplier for supplying the fuel to the reformer, and an oxidant supplier for supplying an oxidant to the reformer and the stack, respectively. Here, the reformer includes the catalyst that includes an active component including a transition metal and a platinum-group metal, and a carrier supporting the active component and including zinc oxide.

### BRIEF DESCRIPTION OF THE DRAWINGS

FIG. 1 is a schematic view of a fuel cell system according to an embodiment of the present invention.

FIG. 2 is an exploded perspective schematic view of a stack of the fuel cell system of FIG. 1.

FIG. 3 is an exploded perspective view of a reformer according to an embodiment of the present invention.

FIG. 4A is a graph showing ethanol variation ratios in accordance with temperature variation in a reformer including a catalyst according to Example 1.

FIG. 4B is a graph showing product concentrations in accordance with temperature variation in the reformer including the catalyst according to Example 1.

FIG. 5A is a graph showing ethanol variation ratios in accordance with temperature variation in a reformer including a catalyst according to Comparative Example 2.

FIG. 5B is a graph showing product concentrations in accordance with temperature variation in the reformer including the catalyst according to Comparative Example 2.

### DETAILED DESCRIPTION

In a fuel cell system, a reformer reforms a hydrocarbon-based fuel into a hydrogen-rich gas required for generating electricity in a stack and also removes harmful materials such as carbon monoxide, which can poison a fuel cell catalyst and shortens its life-span. In general, a reformer includes a reforming section for reforming a fuel and a purifying section for removing carbon monoxide. The reforming section reforms a fuel into a hydrogen-rich gas by utilizing a steam reforming method, a partial oxidation method, an autothermal reforming method, a direct decomposition method, a plasma catalyst reforming method, and/or an adsorption-overreaction reforming method. The purifying section removes carbon monoxide from the hydrogen-rich gas by utilizing a catalyst reaction method, such as water gas shifting, preferential oxidation, etc. and/or a hydrogen-purifying method that uses a separation film.

In one embodiment, ethanol is used as a fuel for a fuel cell. A conventional ethanol reforming catalyst includes a noble metal such as platinum, ruthenium, etc. However, the noble metal catalyst is relative expensive. In addition, the noble metal catalyst requires a relatively high reforming reaction temperature (e.g., more than 700° C.), thereby deteriorating a reactor. In addition, the reforming efficiency is deteriorated due the need to heat the catalyst to the relatively high temperature.

An embodiment of the present invention provides a catalyst that is prepared by supporting an active component including a transition metal as a main component with a relatively small amount of a noble metal on a zinc oxide (ZnO) carrier. This catalyst has a relatively high reforming efficiency and a relatively low reforming reaction temperature, which can protect a reactor from deterioration.

As the main component of the reforming catalyst, the transition metal is used for dehydration, carbon decomposition reaction, and/or alcohol reforming reaction.

The transition metal is a metal belonging to Groups 3 to 11 of the IUPAC periodic table. In one embodiment, the transition metal is Co, Cu, Ni, and/or Fe.

The transition metal may be present in an amount ranging from about 5 to about 20 wt % (or from 5 to 20 wt %) based on the total weight of the catalyst. In one embodiment of the present invention, the transition metal is present in an amount ranging from about 10 to about 15 wt % (or from 10 to 15 wt %) based on the total weight of the catalyst. When the amount of the transition metal is less than 5 wt %, active sites are few so that poisoning of the catalyst may occur. By contrast, when the amount of the transition metal is more than 20 wt %, proper dispersion cannot be attained thereby decrease the performance of the catalyst.

The noble metal may be a platinum-group metal that improves catalyst efficiency for reforming a fuel.

The platinum-group metal may be ruthenium, platinum, rhodium, palladium, and/or iridium. In one embodiment, the platinum-group metal is palladium.

The platinum-group metal may be included in an amount ranging from about 0.1 to about 5 wt % (or from 0.1 to 5 wt %) based on the total weight of the catalyst. In one embodiment, the platinum-group metal is included in an amount ranging from about 0.1 to about 1 wt % (or from 0.1 to 1 wt %) based on the total weight of the catalyst. When the amount of the platinum-group metal is less than 0.1 wt %, coke may be produced to inactivate the catalyst. By contrast, when it is more than 5 wt %, the dispersion degree may be reduced so that performance of the catalyst may be deteriorated.

The active component may include the transition metal and the platinum-group metal in a mole ratio ranging from about 33:1 to about 145:1 (or from 33:1 to 145:1). When the mole ratio of the platinum-group metal with respect to the transition metal in the active component exceeds the above range, the cost of resulting catalyst is high and a side-reaction may occur. By contrast, when the mole ratio of the transition metal with respect to the platinum-group metal is below the above range, reforming efficiency of the fuel may be relatively low and inactivation of the catalyst may occur. The mole ratio of the transition metal to the platinum-group metal may be within a range from about 33:1 to about 133:1 (or from 33:1 to 133:1). In one embodiment, the mole ratio is within a range from about 67:1 to about 125:1 (or from 67:1 to 125:1).

The active component is supported on a carrier including zinc oxide.

The zinc component of the zinc oxide stabilizes the transition metal in the active component.

The catalyst may further include a co-catalyst that uniformly disperses the active sites, thereby improving catalytic activity.

The co-catalyst may be a metal selected from the group consisting of an alkali metal, an alkaline-earth metal, and combinations thereof. In one embodiment, the co-catalyst is Na, Ca, K, and/or Mg.

The co-catalyst may be included in an amount ranging from about 0.05 to about 1.0 mole (or from 0.05 to 1.0 mole) based on 1 mole of the transition metal. In one embodiment, the co-catalyst is included in an amount ranging from about 0.1 to about 0.5 moles (or from 0.1 to 0.5 moles) based on 1.0 mole of the transition metal. When the co-catalyst amount is less than 0.05 moles, catalyst poisoning by side-reaction may occur. By contrast, when it is more than 1.0 mole, the active sites are reduced so that catalyst performance may be deteriorated.

The catalyst may be applied to a reformer for reforming a hydrocarbon-based fuel. Here, the catalyst reforms a fuel with a relatively high efficiency even though it has a relatively small amount of platinum-group metal, and it can also reduce CO. In addition, the catalyst has a reaction temperature of less than 500° C. to ensure reactor durability and reduce adiabatic space.

In addition, the reforming catalyst can be used to effectively reform liquid alcohol fuel such as methanol, ethanol, etc.

In one embodiment, the reforming catalyst can be prepared according to the following method that includes using a platinum-group metal-containing compound, a transition metal-containing compound, and a Zn-containing compound; subjecting the catalyst precursor solution to co-precipitation and aging to obtain a solution; filtering the solution to obtain a filtrate; and drying the filtrate and firing the resultant.

The method of preparing the catalyst is described in more detail hereinafter. First, a platinum-group metal-containing compound, a transition metal-containing compound, and a Zn-containing compound are mixed to prepare a catalyst precursor solution.

The platinum-group metal-containing compound may be selected from the group consisting of platinum-group metal-containing nitrates, halides, carbonyl-based compounds, oxides, and combinations thereof. Examples of the platinum-group metal-containing compound are selected from the group consisting of Ru(NH₃)₆Br₂, RuCl₂(PPh₃)₃, RuClH(CO)(PPh₃)₃, Ru₃(CO)₁₂, PtCl₄, H₂PtCl₆, Pt(NH₃)₄Cl₂, Na₃RhCl₆, RhCl₃, (NH₄)₂PdCl₆, PdCl₂, Pd(NO₃)₂, (NH₄)₂IrCl₆, IrCl₃, and combinations thereof.

The transition metal-containing compound includes metals belonging to Groups 3 to 11 of the IUPAC periodic table. Examples of the transition metal-containing compound are selected from the group consisting of transition metal-containing nitrates, halides, hydroxides, carboxylates, oxides, and combinations thereof. In one embodiment of the present invention, the transition metal-containing compound is selected from the group consisting of Ni(NO₃)₂, NiCl₂, Ni(OH)₂, Ni(CH₃COO)₂, Co(NO₃)₂, Co(OH)₂, COCl₂, CoF₃, and combinations thereof.

The Zn-containing compound may be selected from the group consisting of Zn-containing nitrates, sulfates, oxides, halides, hydroxides, and combinations thereof. In one embodiment of the present invention, the Zn-containing compound is Zn(NO₃)₂₋₆H₂O, etc.

The mixing ratio of the platinum-group metal-containing compound, the transition metal-containing compound, and the Zn-containing compound may be controlled according to the amount of the metals in the catalyst.

The catalyst precursor solution may further include a co-catalyst-containing compound including a metal selected from the group consisting of an alkali metal, an alkaline-earth metal, and combinations thereof.

Specific examples of the co-catalyst-containing compound may be selected from the group consisting of a co-catalyst-containing nitrate, a halide, a sulfate, a carbonate, an oxide, and combinations thereof. In one embodiment of the present invention, the co-catalyst-containing compound is selected from the group consisting of BaCl₂, Ba(ClO₃), Ba(NO₃)₂, Ba(SO₃NH₂)₂, MgCO₃, Mg(NO₃), MgSO₄, Na₂CO₃, and combinations thereof.

The prepared catalyst precursor solution is subjected to co-precipitation and then aging.

The co-precipitation is performed at a temperature ranging from about 30 to about 90° C. (or from 30 to 90° C.). In one embodiment, the co-precipitation is performed at a temperature ranging from about 30 to about 70° C. (or from 30 to 70° C.), and in another embodiment, it is performed at a temperature ranging from about 40 to about 60° C. (or from 40 to 60° C.). When the co-precipitation is performed at a temperature of less than 30° C., the reaction rate is too low to be effective. By contrast, when it is more than 90° C., the reaction is performed too quickly such that non-uniformities may occur.

Through the above co-precipitation, Zn ions that are separated from the Zn-containing compound are converted into stable oxides, and platinum-group metal ions and transition metal ions that are respectively separated from the platinum-group metal-containing compound and transition metal-containing compound are reduced to form a stable alloy that can be supported on the oxide.

The aging process is performed for a time period ranging from about 6 to about 48 hours (or from 6 to 48 hours). In one embodiment, it is performed for a time period ranging from about 12 to about 24 hours (or from 12 to 24 hours). When the aging time is less than 6 hours, the reaction time is too short and particles are not formed.

After the aging process, the resultant solution is filtered to obtain a filtrate (S3).

Through the aging process, precipitates can be obtained. The filtering of the resultant solution can be performed according to any suitable filtering process.

The resulting filtrate is optionally washed in order to remove impurities.

The filtrate is then dried and fired and a firing process (S4).

The drying of the filtrate is performed by any suitable drying method such as air drying, hot wind drying, and so on. The firing can be performed within a suitable temperature for catalyst preparation.

The resulting product after the firing process can be applied as a catalyst for a reformer of a fuel cell. Alternatively, the resulting product can be subjected to pelletizing or sieving so that it may have an appropriate size.

The reforming catalyst prepared in accordance to the above method may be applied to a reformer for a fuel cell. The reformer may have various structures without limiting to a specific structure. Because the catalyst ensures reactor durability due to its relative low reaction temperature of about 500° C. or less, the reforming catalyst can be applied to a reformer having a laminated structure that may easily rupture under a relatively high temperature.

According to other embodiments of the present invention, a reformer and a fuel cell system including the reforming catalyst prepared in accordance to the above method are provided.

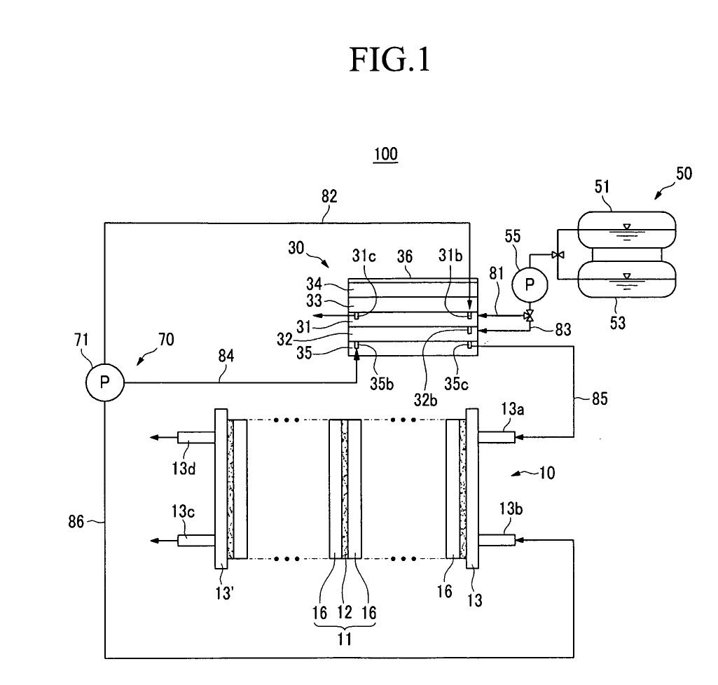

FIG. 1 is a schematic view of a fuel cell system according to an embodiment of the present invention.

In the fuel cell system 100 shown in FIG. 1, a polymer electrode membrane fuel cell (PEMFC) in which hydrogen-rich gas is generated by reforming fuel containing hydrogen is provided, and electrical energy is generated by an electrochemical reaction of the hydrogen-rich gas and an oxidant gas.

In the fuel cell system 100, the fuel for generating electricity includes a liquid or gas fuel containing hydrogen such as methanol, ethanol, and natural gas. In the following, the fuel used will be assumed to be in a liquid form, and a mixed fuel will refer to a fuel composed of a liquid fuel and water.

Furthermore, in the fuel cell system 100, the oxidant gas for reaction with hydrogen gas may be oxygen gas stored in a separate storage container, or it may simply be air containing oxygen. In the following, the oxidant gas used will be assumed to be air containing oxygen.

The fuel cell system 100 includes a stack 10 for generating electrical energy through an electrochemical reaction of hydrogen and oxygen, a reformer 30 for generating hydrogen-rich gas from the fuel and supplying the hydrogen-rich gas to the stack 10, a fuel supplier 50 for supplying the fuel to the reformer 30, and an oxidant supplier 70 for supplying air to the reformer 30 and the stack 10.

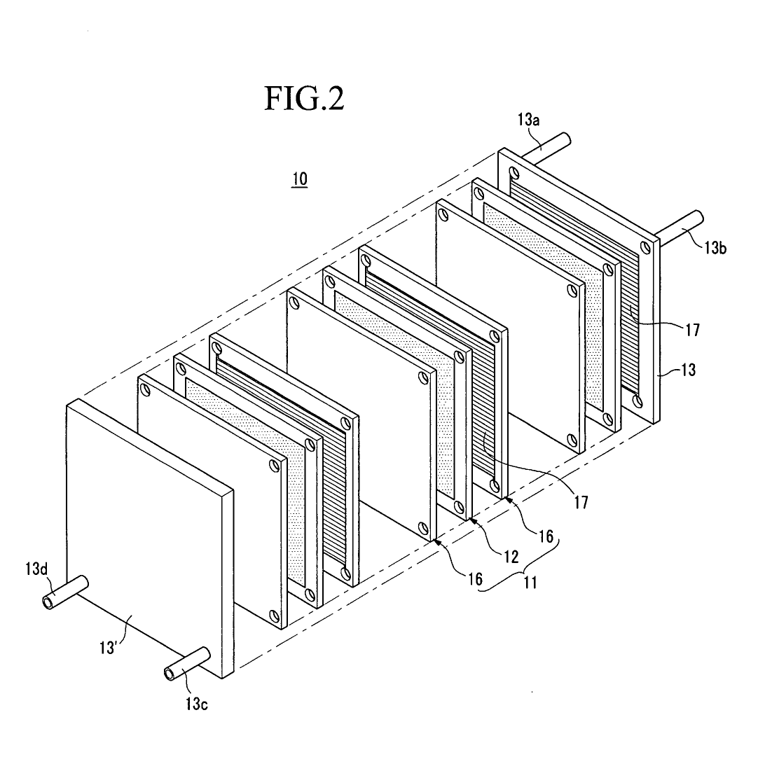

FIG. 2 is an exploded perspective view of the stack 10 of FIG. 1, and the stack 10 is formed by a plurality of electricity generators (or electricity generating elements) 11.

Each of the electricity generating elements 11 includes a unit fuel cell composed of separators 16 (also known as bipolar plates) and a membrane electrode assembly (MEA) 12 between the separators 16.

The MEA 12 has an active region with an area (that may be predetermined) where an electrochemical reaction of hydrogen and oxygen occurs, and it has an anode on one surface, a cathode on the other surface, and an electrolyte membrane interposed between those the anode and the cathode.

An oxidation reaction of hydrogen occurs at the anode to convert the hydrogen to protons and electrons. A reduction reaction of the protons and oxygen occurs at the cathode to generate water and heat at temperature that may be predetermined. The electrolyte membrane transfers the protons generated at the anode to the cathode to exchange ions.

The separators 16 act as a supplier of hydrogen and oxygen to the sides of the MEA 12, and also function as a conductor for connecting the anode and the cathode in series.

Additionally, separate pressing plates 13 and 13′ can be mounted to outermost layers of the stack 10 to press a plurality of the electricity generating elements 11 together. However, in the stack 10 of an embodiment of the present invention, separators 16 positioned in the outermost layers of the electricity generating element 11 may be used in place of the pressing plates 13 and 13′, in which case the pressing plates are not included in the configuration. When the pressing plates 13 are used, they may have a function of the separators 16 mentioned above in addition to pressing together the plurality of electricity generating elements 11. The pressing plates 13 and 13′ and separator 16 may include flow channels 17 thereon.

One pressing plate 13 of the pressing plates 13 and 13′ includes a first inlet 13a for supplying hydrogen gas to the electricity generating elements 11, and a second inlet 13b for supplying air to the electricity generating elements 11. The other pressing plate 13′ includes a first outlet 13c for exhausting hydrogen gas remaining after a reaction in the electricity generating elements 11, and a second outlet 13d for exhausting water generated by a combination reaction of hydrogen and oxygen in the electricity generating elements 11, and air remaining after a reaction with hydrogen. The second inlet 13b may be connected to the oxidant supplier 70 through a sixth supply line 86.

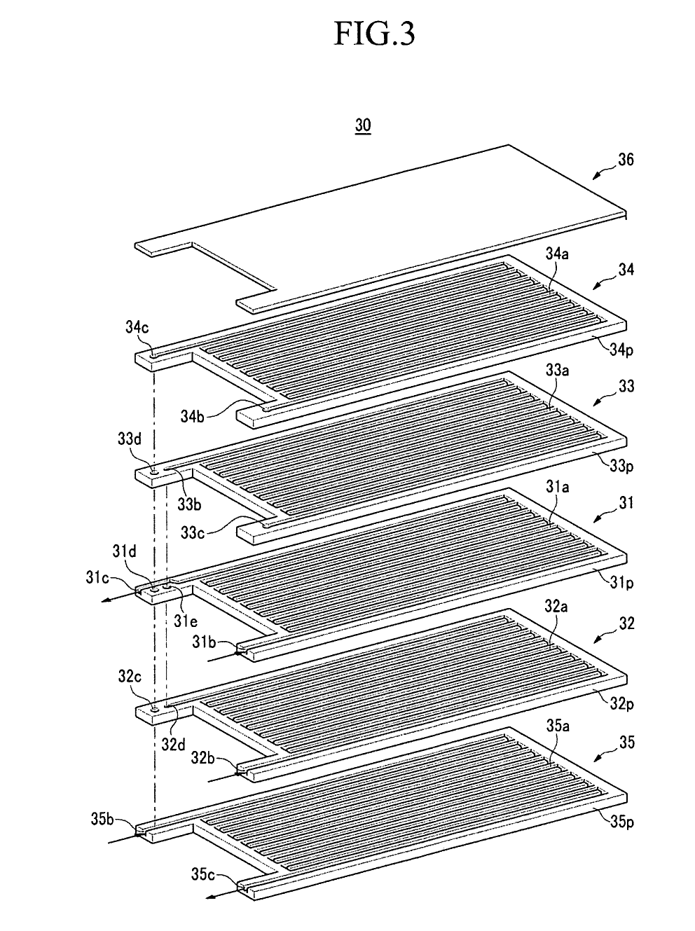

In this embodiment, the reformer 30 generates hydrogen-rich gas from fuel containing hydrogen through a chemical catalytic reaction by utilizing thermal energy, and reduces the concentration of carbon monoxide contained in the hydrogen-rich gas. The structure of the reformer 30 will be explained in more detail below with reference to FIG. 3.

The fuel supplier 50 for supplying fuel to the reformer 30 includes a first tank 51 for storing liquid fuel, a second tank 53 for storing water, and a fuel pump 55 connected to the first tank 51 and the second tank 53 for discharging the liquid fuel and water from the first tank 51 and the second tank 53.

The oxidant supplier 70 includes an oxidant pump 71 for performing the intake of air using a pumping force that may be predetermined and for supplying the air to the electricity generating elements 11 of the stack 10 and to the reformer 30. In this embodiment, the oxidant supplier 70 has a structure such that air is supplied to the stack 10 and the reformer 30 through one oxidant pump 71, but the present invention is not limited thereto. For example, a first air pump and a second air pump can be connected to the stack 10 and the reformer 30, respectively.

When the system 100 supplies a hydrogen-rich gas generated from the reformer 30 to the stack 10 and supplies air to the stack 10 through the oxidant pump 71, the stack 10 generates an amount of electrical energy (that may be predetermined), water, and heat through an electrochemical reaction of hydrogen and oxygen.

In addition, the fuel cell system 100 can control, for example, operation of the fuel supplier 50, the oxidant supplier 70, etc., by use of a general control unit including a microcomputer.

Hereinafter, the structure of the reformer 30 will be explained in more detail with reference to FIG. 3.

FIG. 3 is an exploded perspective view of the reformer 30 according to an embodiment of the present invention.

In the exemplary embodiment, the reformer 30 includes a plurality of reactors 31, 32, 33, 34, and 35 that are stacked adjacent to one another, and that generate thermal energy through an oxidation catalytic reaction of fuel and air, generate hydrogen-rich gas from mixed fuel through various suitable catalytic reactions by the thermal energy, and reduce the concentration of carbon monoxide contained in the hydrogen-rich gas.

The reformer 30 includes a thermal energy generating element for generating thermal energy through a catalytic oxidization reaction of fuel and an oxidant, and a hydrogen gas generating element for generating hydrogen-rich gas by being separately supplied with fuel from the thermal energy generating element and adsorbing the thermal energy from the thermal energy generating element. In one embodiment, the hydrogen gas generating element includes the above described reforming catalyst.

In more detail, the reformer 30 includes a first reactor 31 for generating thermal energy, a second reactor 32 for vaporizing mixed fuel by the thermal energy provided from the first reactor 31, and a third reactor 33 for generating hydrogen-rich gas from the vaporized mixed fuel. The first to third reactors 31, 32, and 33 are stacked adjacent to one another to form an integrated structure.

According to another embodiment, the reformer 30 may further include a fourth reactor 34 for performing a primary reduction of the concentration of carbon monoxide contained in the hydrogen-rich gas through a water-gas shift (WGS) catalytic reaction of the hydrogen-rich gas, and a fifth reactor 35 for performing a secondary reduction of the concentration of carbon monoxide contained in the hydrogen-rich gas through a preferential CO oxidation (PROX) catalytic reaction of the hydrogen-rich gas and air.

In the exemplary embodiment, the reformer 30 is structured such that the third reactor 33 and the fourth reactor 34 are sequentially stacked on an upper side of the first reactor 31, and the second reactor 32 and the fifth reactor 35 are sequentially stacked on the lower side of the first reactor 31. Each of the reactors 31, 32, 33, 34, and 35 has a channel that allows fuel, air, hydrogen gas, etc. to flow, and a mechanism for connecting each of the channels to each other.

Further, a cover 36 may be mounted on a side of the fourth reactor 34 facing away from the third reactor 33. The first through fifth reactors 31, 32, 33, 34, and 35 may be in the form of rectangular (or quadrilateral) plates having a length and a width (that may be predetermined), and may be formed of a metal having a relatively high thermal conductivity, such as aluminum, copper, and steel.

The first reactor 31 is a heating element that generates thermal energy required for reforming fuel, and it pre-heats the entire reformer 30. The first reactor 31 performs combustion of fuel and air by an oxidation catalytic reaction.

The first reactor 31 includes a first body 31p in the form of a rectangular (or quadrilateral) plate. A first flow channel 31a is formed in the first body 31p to enable the flow of fuel and air. The first flow channel 31a has a start end and a finish end, and is formed on the upper side of the first body 31p. Further, a catalyst layer is formed on the inner surface of the first flow channel 31a for accelerating the oxidation reaction of the fuel and air.

Further, a first inflow hole 31b is formed in the first body 31p to supply fuel and air to the first flow channel 31a. A first exhaust hole 31c is also formed in the first body 31p to exhaust combusted gas generated by combusting fuel and air through the first flow channel 31a. The first inflow hole 31b is formed in the start end of the first flow channel 31a, and the first exhaust hole 31c is formed in the finish end of the first flow channel 31a. Further, a first through-hole 31d and a second through-hole 31e are formed in the area of the first exhaust hole 31c.

The first inflow hole 31b can be connected to the first tank 51 of the fuel supplier 50 through a first supply line 81 and to the oxidant pump 71 of the oxidant supplier 70 through a second supply line 82 (see FIG. 1).

The second reactor 32 receives the supply of mixed fuel from the fuel supplier 50, and the second reactor 32 receives thermal energy from the first reactor 31 to vaporize the mixed fuel.

The second reactor 32 includes a second body 32p in the form of a rectangular (or quadrilateral) plate. A second flow channel 32a is formed in the second body 32p to enable the flow of the mixed fuel. The second flow channel 32a has a start end and a finish end, and is formed on a side (or an upper side) of the second body 32p facing away from the fifth reactor 35. A catalyst layer is formed on the inner surface of the second flow channel 32a for accelerating the vaporization of the mixed fuel.

Further, a second inflow hole 32b is formed in the second body 32p to supply mixed fuel to the second flow channel 32a. The second inflow hole 32b is formed in the start end of the second flow channel 32a. In addition, a third through-hole 32c for communicating with the first through-hole 31d of the first reactor 31 is formed in the second body 32p, and a first groove 32d for communicating with the second through-hole 31e is formed in the finish end of the second flow channel 32a.

The second inflow hole 32b can be connected to the first tank 51 and the second tank 52 of the fuel supplier 50 through a third supply line 83 (see FIG. 1).

The third reactor 33 generates hydrogen-rich gas from the vaporized mixed fuel of the second reactor 32 through a steam reforming catalytic reaction.

The third reactor 33 includes a third body 33p in the form of a rectangular (or quadrilateral) plate. A third flow channel 33a is formed in the third body 33p to enable the flow of the vaporized mixed fuel. The third flow channel 33a has a start end and a finish end, and is formed on a side of the third body 33p. Further, a catalyst layer is formed on the inner surface of the third flow channel 33a for accelerating a reforming reaction of the vaporized mixed fuel. In one embodiment, the above described reforming catalyst is filled in or coated on the inner surface of the third flow channel 33a as the catalyst layer.

In order to enable the reception of vaporized mixed fuel from the second reactor 32, the third body 33p has a fourth through-hole 33b formed in the start end of the third flow channel 33a for communicating with the second through-hole 31e of the first reactor 31, a second groove 33c formed in the finish end of the third flow channel 33a, and a fifth through-hole 33d for communicating with the first through-hole 31d of the first reactor 31.

The fourth reactor 34 increases the concentration of hydrogen through a water-gas shift catalytic reaction of the hydrogen-rich gas generated by the third reactor 33, and performs a primary reduction of the concentration of carbon monoxide contained in the hydrogen-rich gas.

The fourth reactor 34 includes a fourth body 34p in the form of a quadrilateral plate. A fourth flow channel 34a is formed in the fourth body 34p to enable the flow of the hydrogen-rich gas. The fourth flow channel 34a has a start end and a finish end, and is formed on the upper side of the fourth body 34p. Further, a catalyst layer is formed in the fourth flow channel 34a for accelerating the water-gas shift reaction.

Further, the fourth reactor 34 has a sixth through-hole 34b formed in the start end of the fourth flow channel 34a for communicating with the second groove 33c of the third reactor 33, and a seventh through-hole 34c formed in the finish end of the fourth flow channel 34a for communicating with the fifth through-hole 33d of the third reactor 33.

The fifth reactor 35 performs secondary reduction of the concentration of carbon monoxide contained in the hydrogen-rich gas through a preferential CO oxidation (PROX) catalytic reaction of air and the hydrogen-rich gas generated in the fourth reactor 34.

The fifth reactor 35 includes a fifth body 35p in the form of a quadrilateral plate. A fifth flow channel 35a is formed in the fifth body 35p to enable the flow of the hydrogen-rich gas generated in the fourth reactor 34. The fifth flow channel 35a has a start end and a finish end, and is formed on the upper side of the fifth body 35p. A catalyst layer is formed in the fifth flow channel 35a for accelerating the above preferential CO oxidation reaction.

Further, the fifth body 35p has a third inflow hole 35b for supplying air to the fifth flow channel 35a and a second exhaust hole 35c for exhausting the hydrogen-rich gas, the carbon monoxide concentration of which is reduced through the fifth flow channel 35a. The third inflow hole 35b is formed in the start end of the fifth flow channel 35a, and the second exhaust hole 35c is formed in the finish end of the fifth flow channel 35a.

The third inflow hole 35b can be connected to the oxidant pump 71 of the oxidant supplier 70 through a fourth supply line 84. The second exhaust hole 35c can be connected to the first inlet 13a of the stack 10 through a fifth supply line 85 (see FIG. 1).

When the reactors 31, 32, 33, 34, and 35 are stacked adjacent to one another, the first through-hole 31d, the third through-hole 32c, the fifth through-hole 33d, the seventh through-hole 34c, and the third inflow hole 35b are arranged to communicate with one another. Further, the second through-hole 31e, the fourth through-hole 33b, and the first groove 32d are arranged to communicate with one another. The sixth through-hole 34b and the second groove 33c are also arranged to communicate with each other. These arrangements enable the reactors 31, 32, 33, 34, and 35 to couple their channels as one path (from the second reactor to the fifth reactor). In this embodiment, the path is formed through a through-hole or groove formed on each reactor, but the present invention is not limited to the above structure.

In the above reformer 30, fuel and air are provided in opposite directions from each other, and the oxidation exhaust gases heat reforming reactants. Resulting vaporized reactants are provided to a reforming reaction layer. By considering the amount of hydrogen for the above reactions, the required catalyst layer volume and the number of stacked reactors can be controlled.

In the reformer according to one embodiment, the intervals among the reactors that are connected in parallel are controlled such that reactant may be provided at a substantially uniform inflow amount and inflow rate, and the second and third reactors may be connected in series. The second reactor has a microchannel resulting in maximizing heat-exchange performance. The above described reforming catalyst can be filled in or coated on the third reactor.

The reformer having the above structure may be operated at a temperature ranging from about 300 to about 600° C. (or from 300 to 600° C.). In one embodiment, the reformer can be operated at a temperature ranging from about 450 to about 550° C. (or from 450 to 550° C.). When the reformer is operated at a temperature of less than 300° C., reactivity may be deteriorated. By contrast, when the reformer is operated at a temperature of more than 600° C., side reaction products such as CO may increase.

In addition, the pressure of the reformer is kept at about 0.1 atm or more (or at 0.1 atm or more). In one embodiment, the pressure of the reformer is kept at about 0.01 atm or more (or at 0.01 atm or more). That is, when the pressure drop of the reformer is more than 0.1 atm, the supplier pumps may be overstrained.

As described above, the fuel cell system of an embodiment of the present invention has a structure such that the efficiency of the reformer and the performance of the entire system are improved by stacking each of the reactors adjacent to one another.

Further, since an embodiment of the present invention can simplify the structure of the reformer, the entire fuel cell system can be made more compact, and thereby the performance of the reformer can also be enhanced.

The following examples illustrate the present invention in more detail. However, the present invention is not limited by these examples.

### EXAMPLE 1

A catalyst precursor solution was prepared by mixing 0.1 g of (NH₄)₂PdCl₆, 10 g of Co(NO₃)₂.6H₂O, 40 g of Zn(NO₃)₂.6H₂O, and 1.0 g of Na₂CO₃ in 300 cc of solvent. The catalyst precursor solution was co-precipitated and thereafter aged at 80° C. for 12 hours. Then, the aged catalyst precursor solution was filtered to separate a product, and the product was washed with water. The washed product was dried at 120° C. for 6 hours and thereafter fired at 500° C. for 5 hours. The resulting product was pelletized to prepare a PdCoNa/ZnO reforming catalyst with an average particle size of 0.5 mm.

The PdCoNa/ZnO reforming catalyst had a mole ratio of Pd:Co:Na of 1:122:67. Herein, the amounts of the Pd and Co were 0.22 wt % and 15 wt %, respectively, based on the total weight of the catalyst.

### EXAMPLE 2

A catalyst precursor solution was prepared by mixing 0.12 g of Na₃RhCl₆, 10 g of Co(NO₃)₂6H₂O, 40 g of Zn(NO₃)₂.6H₂O, and 1.0 g of Na₂CO₃ in 300 cc of solvent. The catalyst precursor solution was precipitated and thereafter aged at 80° C. for 12 hours. Then, the aged catalyst precursor solution was filtered to separate a product, and the product was washed with water. The washed product was dried at 120° C. for 6 hours and thereafter fired at 500° C. for 5 hours. The resulting product was pelletized to prepare a PdCoNa/ZnO reforming catalyst with an average particle size of 0.5 mm.

The PdCoNa/ZnO reforming catalyst had a mole ratio of Rh:Co:Na of 1:110:60. Herein, the Pd and Co were respectively included in amounts of 0.23 wt % and 15 wt % based on the total weight of the catalyst.

### COMPARATIVE EXAMPLE 1

126 g of cerium nitrate was dissolved in 200 ml of pure water and thereafter impregnated on 200 g of an alumina carrier. The resulting product was dried at 80° C. for 3 hours by using a rotary evaporation device. Next, it was fired at 750° C. for 3 hours to prepare an alumina carrier including ceria.

Then, 40 g of the carrier was impregnated with an aqueous solution prepared by dissolving 4.3 g of ruthenium trichloride and 9.1 g of cobalt nitrate as an active component in pure water, and thereafter dried at 80° C. for 3 hours.

The resultant was dipped in 1 l of a NaOH solution with a concentration of 5 mol/l and slowly agitated for one hour to separate the impregnated compound. Then, the separated compound was completely washed with distilled water and dried at 80° C. for 3 hours, gaining a 4Ru/4Co/18CeO₂/Al₂O₃ catalyst.

### COMPARATIVE EXAMPLE 2

40 g of an alumina carrier was impregnated with an aqueous solution prepared by dissolving 4.3 g of ruthenium trichloride as an active component in 30 ml of pure water. The resulting product was dried at 80° C. for 3 hours by using a rotary evaporation device.

Next, the resultant was dipped in 1 l of a NaOH solution with 5 mol/l of concentration and slowly agitated for 1 hour to separate the impregnated compound. The acquired compound was dried at 120° C. for 6 hours and thereafter fired at 500° C. for 5 hours. The resulting product was pelletized to prepare a Ru/Al₂O₃ catalyst with an average particle size of 0.5 mm.

Then, the catalysts for a reformer of a fuel cell according to Examples 1, 2, and Comparative Example 1 were evaluated regarding catalyst efficiency.

The evaluation of catalyst efficiency was performed by fabricating a single cell in the following method.

As shown in FIG. 1, the polymer electrolyte fuel cell was fabricated to include the fuel supplier 50, the oxidant supplier 70, the reformer 30, and the stack 10.

As shown in FIG. 3, the reformer 30 includes the first reactor 31 for generating thermal energy; the second reactor 32 for vaporizing mixed fuel by the thermal energy provided from the first reactor 31; the third reactor 33 for generating hydrogen-rich gas from the vaporized mixed fuel through a steam reforming (SR) catalytic reaction; the fourth reactor 34 for performing a primary reduction of the concentration of carbon monoxide contained in the hydrogen-rich gas through a water-gas shift (WGS) catalytic reaction of the hydrogen-rich gas; and the fifth reactor 35 for performing a secondary reduction of the concentration of carbon monoxide contained in the hydrogen-rich gas through a preferential CO oxidation (PROX) catalytic reaction of the hydrogen gas and air. The first to fifth reactors 31, 32, 33, 34, and 35 were stacked to form an integrated structure. In addition, the reforming catalysts according to Examples 1, 2, and Comparative Example 1 were included in respective reformers.

The stack 10 includes a unit cell including the membrane-electrode assembly 12 and the separator 16. The membrane-electrode assembly 12 includes an anode, a cathode, and an electrolyte membrane interposed therebetween.

The electrolyte membrane includes a solid polymer electrolyte (NAFION™) with an average thickness of 100 μm. The cathode and anode were respectively formed of platinum. The cathode was electrically connected to a carbon monoxide purifier to be provided with electrons produced therefrom.

In the single cells, reformers were supplied with a 20 wt % ethanol aqueous solution for ethanol reform reaction. When the reaction reached a steady state, the amount of H₂, CO₂, and CO in reforming gases acquired from the reaction and the temperature in the reformers were measured. The results are shown in the following Table 1.

TABLE 1

| | | | Comparative |
|---|---|---|---|
| | Example 1 | Example 2 | Example 1 |
| H₂ (volume %) | 72.50 | 72.93 | 72.58 |
| CO₂ (volume %) | 22.5 | 23.1 | 23.0 |
| CO (ppm) | 16 | 12 | 14 |
| Reformer | 510 | 490 | 850 |
| Temperature | | | |
| (° C.) | | | |

As shown in Table 1, the reforming gases passing through the reformers according to Examples 1 and 2 and Comparative Example 1 were supplied with as much H₂, CO₂, and CO as can be supplied into a stack. However, the reformer of Examples 1 and 2 had a reaction temperature of 510° C. or less, while that of Comparative Example 1 had a reaction temperature of 850° C. The reformers of Examples 1 and 2 had lower catalyst reaction temperatures than that of Comparative Example 1. Therefore, the reformers of Examples 1 and 2 have better durability than that of Comparative Example 1.

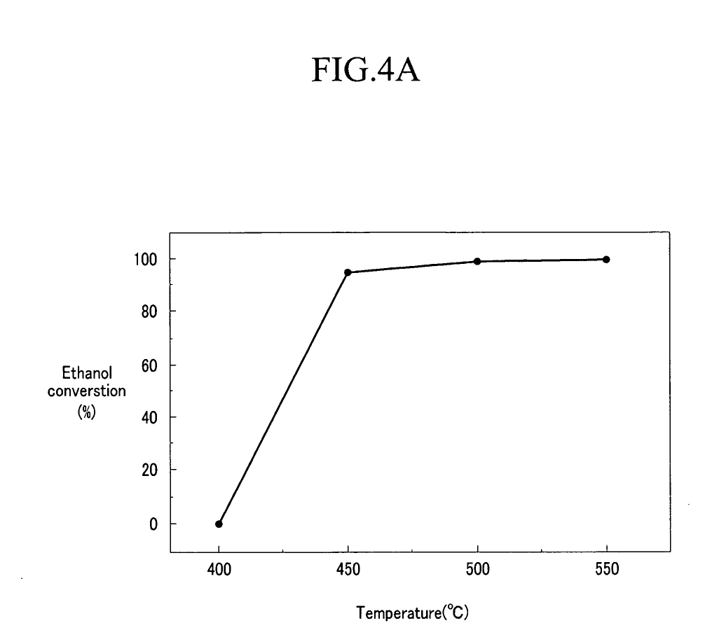

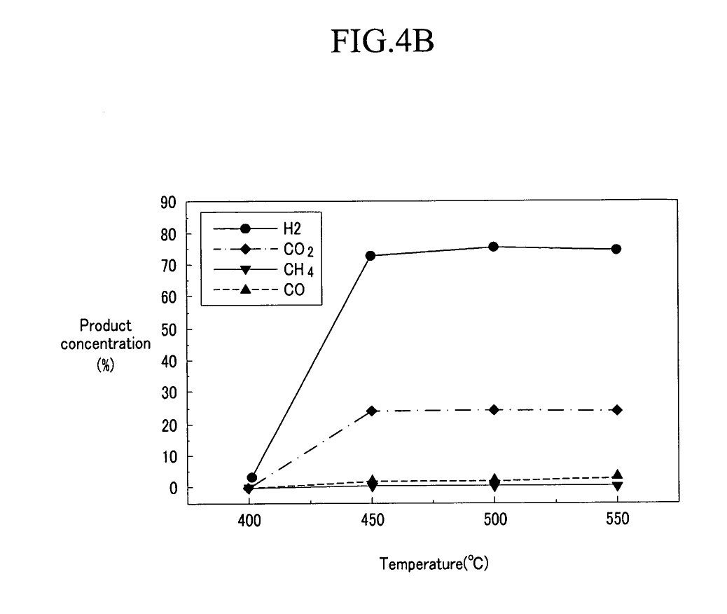

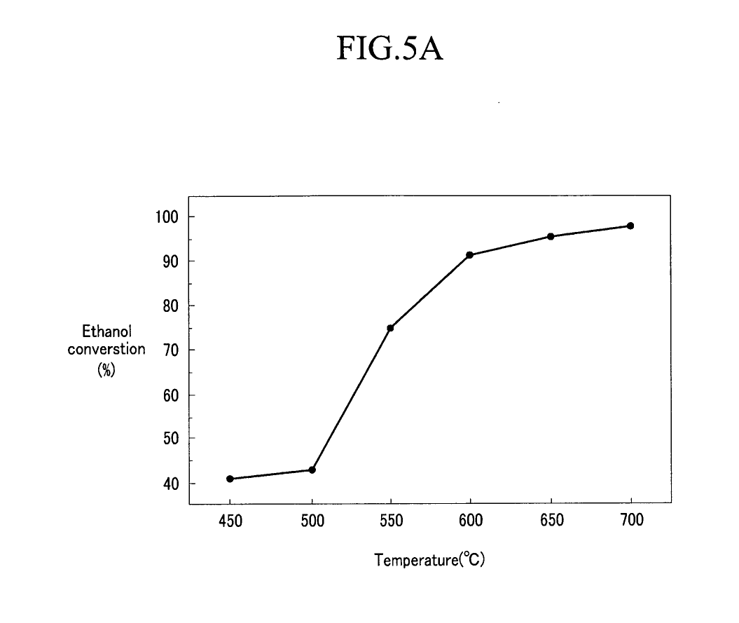

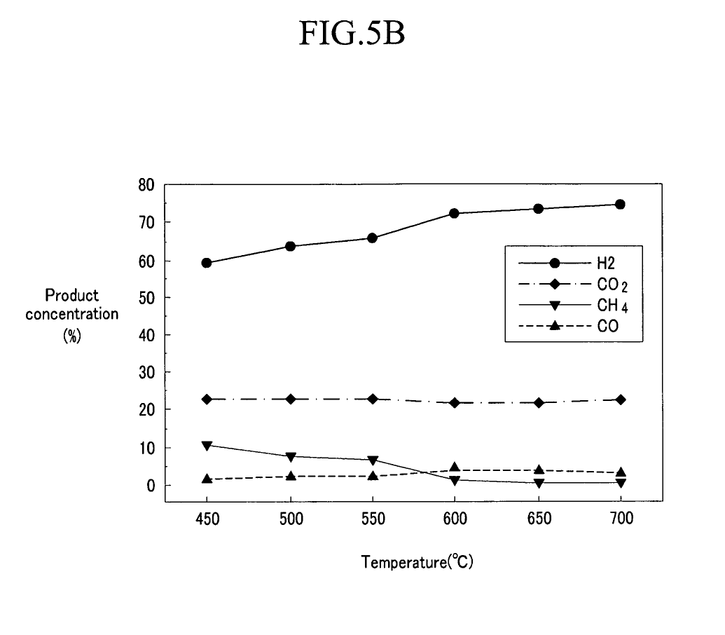

In addition, reformers including a catalyst for a reformer of a fuel cell according to Example 1 and Comparative Example 2 were supplied with a 20 wt % ethanol aqueous solution for an ethanol reforming reaction. Their reforming effects were measured depending on temperature. The results are shown in FIGS. 4A, 4B, 5A, and 5B.

FIGS. 4A and 5A show ethanol variation ratios with respect to temperature in reformers including the catalysts according to Example 1 and Comparative Example 2, respectively, while FIGS. 4B and 5B show concentration of products according to change of temperature in reformers including the catalysts according to Example 1 and Comparative Example 2, respectively.

As shown in FIGS. 4A and 5A, the reforming catalyst of Example 1 had an ethanol conversion rate of almost 100% at 500° C., while that of Comparative Example 2 had an ethanol conversion rate of about 100% at 700° C. Therefore, the reforming catalyst of Example 1 had relatively high catalytic activity with a relatively low reforming reaction temperature.

In addition, as shown in FIGS. 4B and 5B, the reforming gas produced from the reforming reaction of the reforming catalyst of Example 1 had about 2% of CO, while the reforming gas produced from the reforming reaction of the reforming catalyst of Comparative Example 2 had about 5% of CO. Therefore, the reforming catalyst of Example 1 not only had better reform efficiency, but it also decreased CO more than that of Comparative Example 2.

In view of the foregoing, a catalyst for a reformer of a fuel cell according to an embodiment of the present invention can have excellent reforming effects with a relatively small amount of a platinum-group metal, and can also reduce CO. In addition, the catalyst ensures reactor durability due to its relatively low reaction temperature of about 500° C. or less.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A catalyst for a reformer of a fuel cell, the catalyst comprising:
an active component including a transition metal and a platinum-group metal; and
a carrier supporting the active component and including zinc oxide.

2. The catalyst of claim 1, wherein the transition metal comprises a metal selected from the group consisting of Co, Cu, Ni, Fe, and combinations thereof.

3. The catalyst of claim 1, wherein the transition metal is in an amount ranging from about 5 to about 20 wt % based on a total weight of the catalyst.

4. The catalyst of claim 1, wherein the platinum-group metal comprises a metal selected from the group consisting of ruthenium, platinum, rhodium, palladium, iridium, and combinations thereof.

5. The catalyst of claim 1, wherein the platinum-group metal is in an amount ranging from about 0.1 to about 5 wt % based on a total weight of the catalyst.

6. The catalyst of claim 1, wherein the active component comprises the transition metal and platinum-group metal in a mole ratio ranging from about 33:1 to about 145:1.

7. The catalyst of claim 1, wherein the catalyst further comprises a co-catalyst selected from the group consisting of an alkali metal, an alkaline-earth metal, and combinations thereof.

8. The catalyst of claim 7, wherein the co-catalyst is in an amount of 0.05 to 0.5 moles based on 1 mole of the transition metal.

9. The catalyst of claim 1, wherein the catalyst is a reforming catalyst for an alcohol fuel.

10. A method for preparing a catalyst for a reformer of a fuel cell, the method comprising:
preparing a catalyst precursor solution including a platinum-group metal-containing compound, a transition metal-containing compound, and a Zn-containing compound;
subjecting the catalyst precursor solution to co-precipitation and aging to obtain a solution;
filtering the solution to obtain a filtrate; and
drying the filtrate to obtain a resultant and firing the resultant to obtain the catalyst.

11. The method of claim 10, wherein the catalyst precursor solution comprises a transition metal and a platinum-group metal in a mole ratio ranging from about 33:1 to about 145:1.

12. The method of claim 10, wherein the catalyst precursor solution further comprises a co-catalyst-containing compound comprising a metal selected from the group consisting of an alkali metal, an alkaline-earth metal, and combinations thereof.

13. The method of claim 12, wherein the co-catalyst is in an amount ranging from about 0.05 to about 0.5 moles based on 1 mole of the transition metal in the catalyst precursor solution.

14. The method of claim 10, wherein the co-precipitation is performed at a temperature ranging from about 30 to about 90° C.

15. The method of claim 10, wherein the aging is performed for a time period ranging from about 6 to about 48 hours.

16. A reformer for a fuel cell comprising:
a reforming catalyst,
wherein the reforming catalyst comprises:
an active component including a transition metal and a platinum-group metal; and
a carrier supporting the active component and including zinc oxide.

17. The reformer of claim 16, further comprising at least two reactors for containing the reforming catalyst, each of the reactors including a flow channel.

18. The reformer of claim 16, further comprising:
a thermal energy generating element for generating thermal energy through a catalytic oxidization reaction of a fuel and an oxidant; and
a hydrogen gas generating element for containing the reforming catalyst and for generating hydrogen-rich gas by being separately supplied with a fuel from the thermal energy generating element and adsorbing the thermal energy from the thermal energy generating element.

19. The reformer of claim 16, further comprising:
a first reactor for generating thermal energy through a catalytic oxidation reaction of a fuel and an oxidant;
a second reactor for vaporizing a mixed fuel with the thermal energy; and
a third reactor for generating hydrogen-rich gas from the vaporized mixed fuel with the reforming catalyst,
wherein the first, second, and third reactors are stacked adjacent to one another to form an integrated structure.

20. The reformer of claim 19, wherein the fuel is an alcohol.

21. The reformer of claim 20, wherein the alcohol is ethanol.

22. The reformer of claim 16, wherein the transition metal is in an amount ranging from about 5 to about 20 wt % based on a total weight of the catalyst.

23. The reformer of claim 16, wherein the platinum-group metal comprises a metal selected from the group consisting of ruthenium, platinum, rhodium, palladium, iridium, and combinations thereof.

24. The reformer of claim 16, wherein the platinum-group metal is in an amount ranging from about 0.1 to about 5 wt % based on a total weight of the catalyst.

25. The reformer of claim 16, wherein the active component comprises the transition metal and the platinum-group metal in a mole ratio ranging from about 33:1 to about 145:1.

26. The reformer of claim 16, wherein the reforming catalyst further comprises a co-catalyst selected from the group consisting of an alkali metal, an alkaline-earth metal, and combinations thereof.

27. The reformer of claim 26, wherein the co-catalyst is in an amount ranging from about 0.05 to about 0.5 moles based on 1 mole of the transition element.

28. A fuel cell system comprising:
a stack for generating electrical energy through an electrochemical reaction of hydrogen and an oxidant;
a reformer for generating hydrogen-rich gas from the fuel and supplying the hydrogen-rich gas to the stack;
a fuel supplier for supplying the fuel to the reformer; and
an oxidant supplier for supplying an oxidant to the reformer and the stack, respectively,
wherein the reformer comprises a catalyst comprising:
an active component including a transition metal and a platinum-group metal, and
a carrier supporting the active component and including zinc oxide.
